(19) United States
(12) Patent Application Publication
(10) Pub. No.: US 2012/0144013 A1
(43) Pub. Date: Jun. 7, 2012

(54) Discovery of on-path services for media flows

(75) Inventors: Toerless Eckert, Mountain View, CA (US); Subhasri Dhesikan, San Jose, CA (US)

(73) Assignee: CISCO TECHNOLOGY, INC., San Jose, CA (US)

(21) Appl. No.: 12/928,064

(22) Filed: Dec. 1, 2010

(51) Int. Cl. G06F 15/173

(52) U.S. Cl. 709/224

(57) ABSTRACT

In one embodiment, a method includes receiving at a session call manager, service information transmitted from one or more service points on a path for a media flow between a source and a receiver, selecting from the service information, services to apply to the media flow at the service points, and signaling the service points to apply the selected services to the media flow. An apparatus is also disclosed.

### TECHNICAL FIELD

The present disclosure relates generally to discovery of services for media flows.

### BACKGROUND

Media flows in a communications network often require various services at service points within the network. Conventional system configuration for the services is often performed statically. Once a service is put in place and the clients and servers are statically configured for that service, it is difficult to make changes. Network wide discovery of services may be used to improve flexibility and availability of the services, however, this does not scale well for networks with many service points. Network wide discovery of services and service points typically requires configuration of complex location tables in multiple application managers to define the regions for which a particular service point is responsible.

### BRIEF DESCRIPTION OF THE DRAWINGS

FIG. 1 illustrates an example of a network in which embodiments described herein may be implemented.

FIG. 2 depicts an example of a network device useful in implementing embodiments described herein.

FIG. 3 illustrates an example of signaling between nodes in the network of FIG. 1.

FIG. 4 is a flowchart illustrating an overview of a process for on-path discovery of services for media flows at a session control manager.

FIG. 5 is a flowchart illustrating a process at a service point for providing service information for the on-path discovery.

Corresponding reference characters indicate corresponding parts throughout the several views of the drawings.

### DESCRIPTION OF EXAMPLE EMBODIMENTS

### Overview

In one embodiment, a method generally comprises receiving at a session call manager, service information transmitted from one or more service points on a path for a media flow between a source and a receiver, selecting from the service information, services to apply to the media flow at the service points, and signaling the service points to apply the selected services to the media flow.

In another embodiment, an apparatus generally comprises a processor for receiving service information transmitted from one or more service points on a path for a media flow between a source and a receiver, selecting services to apply to the media flow at the service points, and signaling the service points to apply the selected services to the media flow. The apparatus further comprises memory for storing the service information.

In yet another embodiment, an apparatus generally comprises a processor for inserting service information identifying a service available at a service point into flow signaling on a path for a media flow between a source and a receiver, receiving instructions from a session control manager to perform the service for the media flow, and applying the service to the media flow. The apparatus further comprises memory for storing the instructions.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

Network wide discovery of services does not provide information as to whether or not a service point is on the path of a particular media flow for which services are needed. The embodiments described herein automatically discover services and service points along the path of a media flow so that an application can apply services to the media flow. This provides reduced cost of operations for networks with a large number of distributed service points by providing automatic discovery and utilization. The discovery of on-path services allows for use of an on-path protocol for an edge-point to signal services that are needed by a media session to the on-path service points. The on-path signaling is easily extensible with additional signaling elements (e.g., metadata) without complicating the media forwarding plane and without creating cross-platform inconsistencies.

The embodiments operate in the context of a data communications network including multiple network devices (nodes). Some of the devices in the network may be switches, routers, gateways, servers, call managers, service points, media sources, media receivers, proxies, or other network devices.

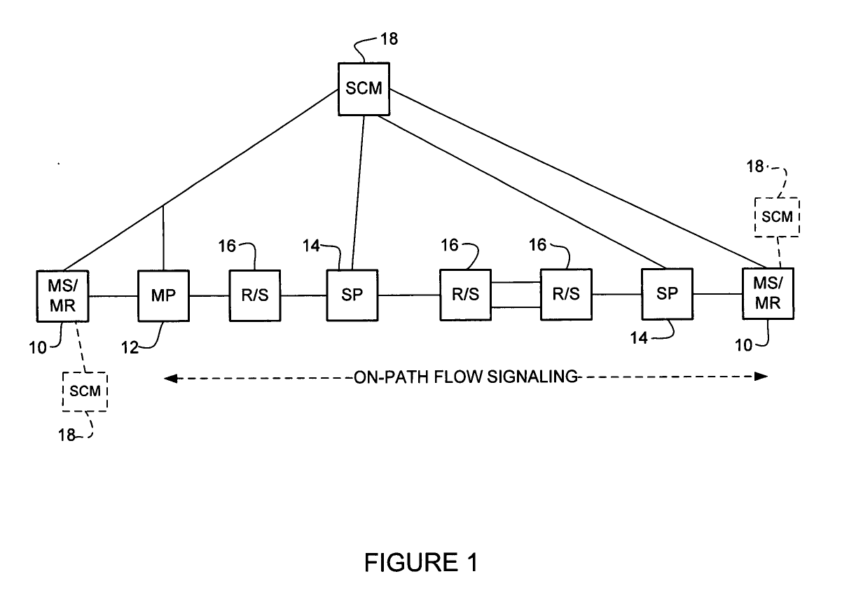

Referring now to the drawings, and first to FIG. 1, an example of a network in which embodiments described herein may be implemented is shown. The network includes a plurality of endpoints (edge-points), including media sources/receivers (MS/MR) 10 or proxies (MP 12) for the media sources/receivers. The media sources/receivers 10 are in communication with service points (SP) 14 via any number of routers or switches (R/S) 16. In one embodiment, the media sources/receivers 10 and service points 14 are in communication with a session control manager (SCM) 18.

The term ‘media’ as used herein refers to video, audio, data, or any combination thereof. The media may be encrypted, compressed, or encoded according to any format. The media content may be transmitted as streaming media or media files, for example.

The endpoints (media sources/receivers 10) are configured to originate or terminate communications over the network. The media sources/receivers 10 may be any device configured for receiving, transmitting, or receiving and transmitting media flows. For example, the media source/receiver 10 may be a server, host, personal computer, media center device (e.g., TelePresence device), mobile device (e.g., phone, personal digital assistant, digital media player), set-top box, content delivery node, or any other media device. A signaling proxy 12 may be used with the media source/receiver 10, as shown in FIG. 1. Therefore, the terms media source/receiver, source, or receiver as used herein may refer to a network device operating as a proxy for the source or receiver.

Intermediate nodes such as routers or switches 16, facilitate passage of data between end nodes. The media flow path may include any number or type of intermediate nodes.

The service point 14 may be a router, switch, gateway, or any other network device that provides a service. The service point 14 may be, for example, a multipoint control unit (MCU), stream splitting device, monitoring device, transcoder/transrater, or multicast/unicast converter as described below. The service points 14 provide information on the services they offer. The services may include, for example, admission control/QoS (Quality of Service), routing (PfR/access-control), monitoring (e.g., mediatrace), encoding, transcoding/transrating, media switching, unicast/multicast conversion, stream splitting, unified communications, directory services, gateway services, or any other service. The service point 14 may be a single physical device or a networked group (e.g., distributed system) of devices or processors and associated network and storage devices, as well as operating software and one or more applications software which support the services provided by the service point 14. In the case of a distributed service point system, only one node (e.g., router) may be in the path of the media flow, however, a server connected to the router in the distributed system would also be considered on-path for the media flow.

The session control manager 18 may be, for example, a call manager, a unified communications manager (UCM), application server, or any other node or application operable to manage media sessions within a media flow in the network. The function of the session control manager may be performed at one or more of the end nodes (e.g., media source/receiver 10 as shown in FIG. 1) so that the network does not need a central SCM 18. It is to be understood that reference to a session control manager (or SCM) as used herein may describe a standalone device or a session control manager function performed at the media source/receiver 10 or other network node (e.g., proxy 12) or combination of nodes. As described further below, the session control manager 18 discovers the existence, location, and configuration of service points and services in a media flow path.

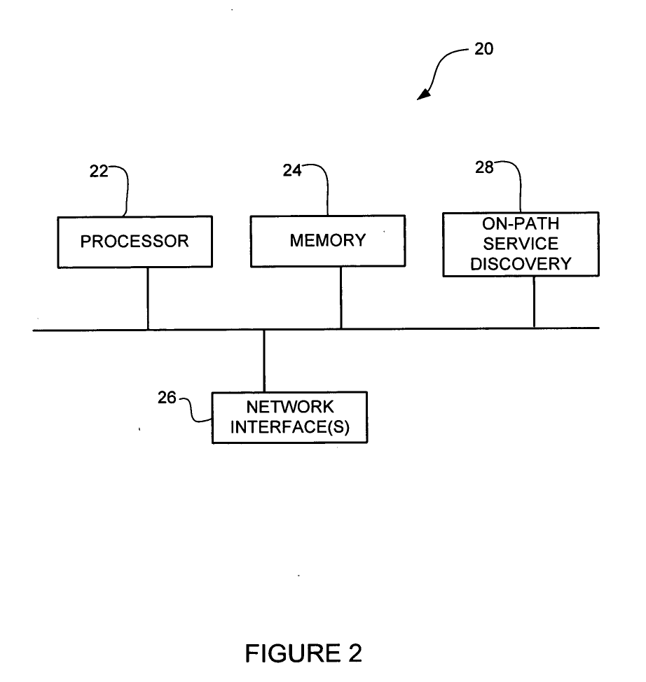

The nodes 10, 12, 14, 16, 18 are connected via communication links (wired or wireless). One or more nodes may be connected by multiple links to provide a backup path in the case of a failure. The network devices shown in FIG. 1 may be implemented on a general purpose machine as described below with respect to FIG. 2

It is to be understood that the network shown in FIG. 1 and described herein is only an example and that the embodiments may be implemented in networks having different network topologies and network devices, without departing from the scope of the embodiments.

An example of a network device 20 (e.g., media source/receiver 10, proxy 12, session control manager 18, service point 14) that may be used to implement embodiments described herein, is shown in FIG. 2. In one embodiment, network device 20 is a programmable machine that may be implemented in hardware, software, or any combination thereof The device 20 includes one or more processors 22, memory 24, one or more network interfaces 26, and a service discovery module 28 (e.g., application stored in memory 24), which provides on-path service discovery functions, as described in detail below. Memory 24 may be a volatile memory or non-volatile storage, which stores various applications, modules, and data for execution and use by the processor 22. Data such as service information or service instructions, for use with on-path service discovery, may also be stored in memory 24.

Logic may be encoded in one or more tangible media for execution by the processor 22. For example, the processor 22 may execute codes stored in a computer-readable medium such as memory 24. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The network interface 26 may comprise one or more wireless or wired interfaces (linecards, ports) for receiving signals or data or transmitting signals or data to other devices. The interfaces 26 may include, for example, an Ethernet interface for connection to a computer or network.

It is to be understood that the network device 20 shown in FIG. 2 and described above is only one example and that different configurations of network devices may be used.

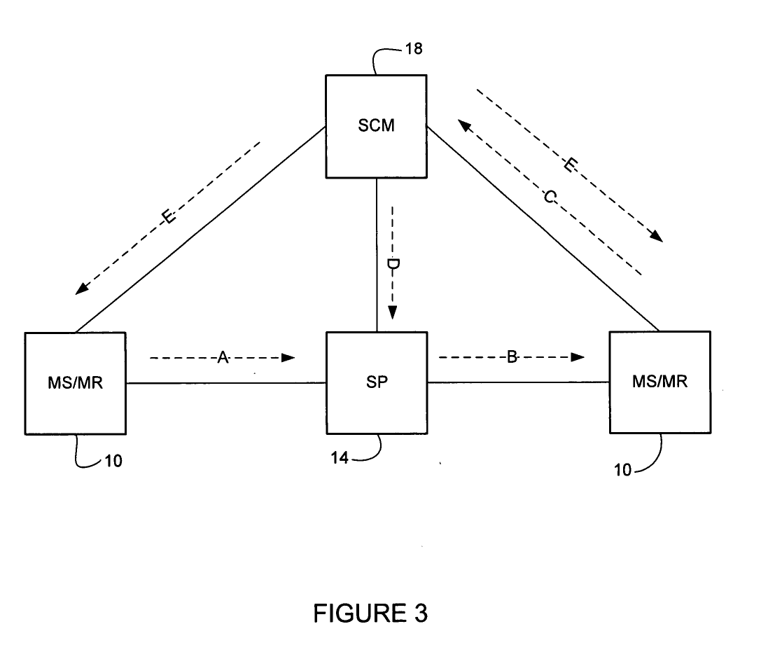

FIG. 3 illustrates communications between nodes in FIG. 1. For simplification, only a portion of the nodes and flow paths are shown in FIG. 3. A media session (e.g., streaming or collaborative) is built with on-path flow signaling (flow path A). In one embodiment, RSVP (Resource Reservation Protocol) is used. RSVP messages travel along the same path as the media flow in a unidirectional manner and flow transparently through non-RSVP nodes.

Service points 14 along the path of the on-path flow signaling insert information about their services into the flow (flow path B). The information includes, for example, services, contact information (e.g., IP address), attributes, properties, etc. These messages may also be transmitted using RSVP, for example.

The edge-points (e.g., media source/receivers 10 or proxies 12) pass the information they receive about the service points 14 to the session control manager 18 (flow path C). The information may be transmitted using, for example, RTP (Real-Time Protocol), RTCP (Real-Time Transport Control Protocol), SIP (Session Initiation Protocol), H.323, etc.

The session control manager 18 interacts with the media source/receivers 10 (or their proxies 12) to learn about the on-path service points 14 and instructs the service points 14 to perform actions, either via additional signaling through the media source/receiver 10 or directly towards the detected service points. For example, as shown in FIG. 3, the session control manager 18 utilizes the on-path discovered service point/service information to select a service to instantiate on the service point 14 and signals instructions to the service point (flow path D). The signaling may be performed using, for example, H.248, XML (Extensible Markup Language), COPS (Common Open Policy Server), Web 2.0, etc. This triggers the service in the services point 14 to apply for the media flow. In order to achieve the desired behavior, the session control manager 18 may also signal the edge-points (media sources/receivers 10 or proxy 12) to change or adopt their behavior so that the media session can benefit from the service point (flow paths E).

It is to be understood that the protocols noted above for the different communication flows (A, B, C, D, E) are only examples and that other protocols may be used without departing from the scope of the embodiments. Also, as previously described, the session control manager functions may be performed at the endpoints rather than a dedicated SCM 18. In this case, the media source/receivers 10 would select which services to instantiate on which service points 14 and signal this information to the service points (flow path D would be from MS/MR 10 to SP 14 and there would be no flow path E).

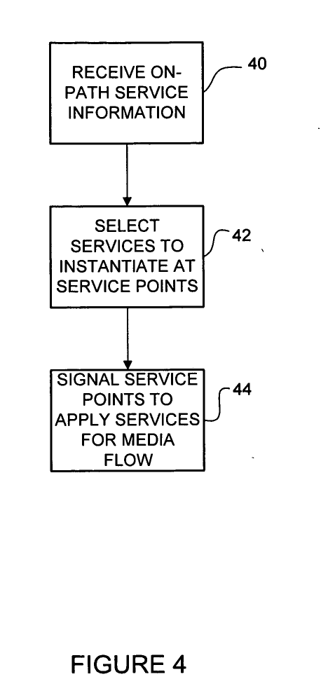

FIG. 4 is a flowchart illustrating an overview of a process for discovery of on-path services for media flows. At step 40, the session control manager 18 receives on-path service information transmitted from one or more service points 14 on a path for a media flow between a source and receiver (media source/receivers 10). As described above with respect to FIG. 1, the session control manager 18 may be a central device or may be located at one or more of the media sources/receivers 10, or other node in the network. The service information transmitted from the service point 14 may be sent directly to the session control manager 18 (e.g., if the SCM is located at the media source/receiver 10) or forwarded from the media source/receiver or other node to the session control manager. The session control manager 18 selects services to instantiate at the service points 14 (step 42) and signals the service points to apply the selected services for the media flow (step 44). The session control manager 18 may signal the service points 14 directly or via the media source/receiver 10 or proxy 12.

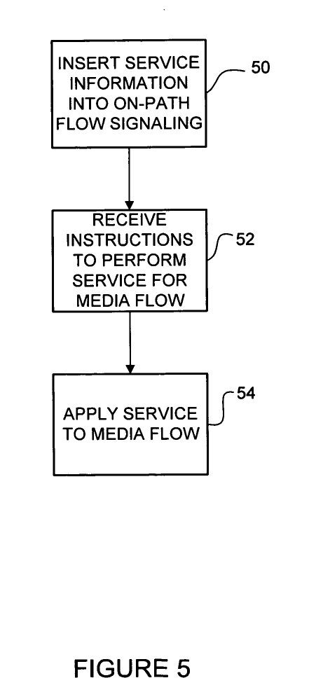

FIG. 5 is a flowchart illustrating a process at the service point 14 for providing service information for the on-path discovery. At step 50, the service point inserts service information into the on-path flow signaling. The service point receives instructions from the session control manager 18 to perform a service for the media flow (step 52) and applies the service to the media flow (step 54).

It is to be understood that the processes illustrated in FIGS. 4 and 5 and described above are only examples and that steps may be added or removed, without departing from the scope of the embodiments.

Path changes may impact whether a service point stays on-path for a particular media flow. Path changes may be handled by detecting and applying new service points or by locking the flow path for a media flow through a specified service point. Details of these two embodiments are described below.

In one embodiment, when the path changes, the on-path flow signaling discovers all service points 14 available on the new path (as well as those that are no longer on-path). This information is signaled to the session control manager 18, which takes corrective action. For example, the session control manager 18 may stop the service for the flow on the now out-of-path service point 14 and instantiate it in the new on-path service point. New service points 14 may be discovered with a periodic refresh of the on-path protocol (as is available with RSVP, for example).

In another embodiment, when a particular service is deemed to be important such that it should not be interrupted by path changes, the service point 14 associated with the service operates as a media termination point (or trusted relay point). Rather than transparently passing the media flow, the service point 14 acts as a transport level repeater. The service point 14 operates as a transport layer (e.g., UDP) receiver of the flow and passes the flow out as a sender. The service point 14 is thereby locked into the media flow. Modification of the session so that the service point 14 acts as a media termination point, may be subject to session layer signaling from the session control manager 18.

The network may also have service point announcement and discovery mechanisms, such as SAF (Service Advertisement Framework) in place. If a service point 14 supports another service announcement mechanism, it may be possible to constrain the amount of service information that the service point 14 needs to insert into the on-path flow signaling (flow path B in FIG. 3), thereby keeping the signaling lightweight. For example, the service point 14 may insert into the on-path flow signaling a service profile, but not the full set of properties for each service.

The following describes examples of implementations of the on-path service discovery described above.

In one example, the embodiments are used for discovery and instantiation of a service point 14 that is a local ad-hoc multiparty media switch/MCU (multipoint control unit). This may be used, for example, for distributed MCUs in routers within network branches. In this example, embodiments described herein may be used to alleviate the need to configure location type central policies to determine when to use which MCU. The session control manager 18 does not need to be aware of these ad-hoc MCUs upfront. The session control manager 18 discovers the ad-hoc MCUs that are on-path when the session is established as a peer-to-peer call. For example, the session control manager may detect two MCUs, one each in the branches of call participants. When ad-hoc conferencing is done, an additional session leg from the initiator of the ad-hoc session is built to the new participant. The session control manager also detects the available MCUs on the other call leg. In order to conference both calls, the session control manager decides which MCU to use. If one of the MCUs is present on both prior call legs, then this is the preferred MCU to use. Otherwise, the MCU can be chosen from the MCUs on both call legs based on other criteria.

In another example, the embodiments are used for detection and instantiation of stream splitting (e.g., media forking service point functionality in a router or switch). The on-path service point 14 may be used, for example, for recording of media flows via recording servers, ORAs (open recording architectures), or other recording or processing services. The session control manager 18 determines where to best fork traffic off of the main path and send copies to a recording server. The session control manager may determine the following upon establishment of a session or at some point during the session: whether the session needs to be recorded; which media-flows need to be recorded; to which recording device which media-flow is to be recorded; and if any media flow recording requires additional redundancy (e.g., forking the same media stream from different media-forking service points to the same recording/processing point). The session control manager 18 learns via the signaling sent from the service points 14, which recording/processing service points are available on the path for each of the media flows. On-path signaling may be triggered from the source endpoint to the target recording/processing device for the purpose of detecting on-path media-forking service points. The same process described above for an MCU can be used for the session control manager to determine the best forking service point for the media flows from a particular endpoint to the target recording/processing device.

In another example, the embodiments may be used to discover monitoring at a service point 14. For example, an upstream PfR (performance routing) router may find and activate passive monitoring at a downstream PfR edge router so that it can make monitoring based quality routing decisions. PfR integrated with RSVP may be used where there are multiple paths between routers within the flow path from the source to the receiver. In the simplified example shown in FIG. 1, two routers 16 have two paths therebetween. There may be multiple receivers in the case of multicast. With an RSVP signaled media flow from the source to the receiver, the router receiving flow from the source (referred to as the upstream router) would like to make intelligent decisions via PfR about which media path to choose for the flows. The downstream router receives flow from the upstream router and transmits it to the receiver. The downstream router is configured to perform passive monitoring of media flows, which can provide a varying degree of quality measurements that may also be different for different types of media flows. The embodiments described herein may be implemented to provide feedback from the downstream router to the upstream router. When the upstream router sees an RSVP signaled media flow, it inserts the service point discovery signaling by which it asks the target for the first PfR tail-end router (service point), as follows: if you support passive monitoring, instantiate monitoring of this flow (parameters) and send results of monitoring information to me; if you cannot execute this, tell me. This allows the upstream router to automatically detect a tail-end PfR router (downstream router) for a flow and instantiate the monitoring. This also ensures that the monitoring results are returned to the upstream router because they will be returned explicitly, as opposed to using conventional mechanisms (e.g., TCP (Transmission Control Protocol) ACK (acknowledgement) packets, RTCP), which may not be path aligned and are limited in accuracy and flexibility.

In another example, the embodiments may be used for discovery and instantiation of on-path transcoding/transrating service points for P2P (peer-to-peer) sessions. This can be used to establish interoperability between endpoints that natively support incompatible video profiles. For example, the embodiments may be used in the presence of distributed service points with transcoding/transrating capabilities (e.g., branch routers). Two endpoints (e.g., in a P2P call) may not be able to achieve the best possible audio/video quality because the best common codec is much worse than the highest quality codec at either endpoint. If a transcoder could be used, the experience would be optimized. The embodiments are applied on a path containing one or more service points 14 that can act as transcoders/transraters. When the session control manager learns about the transcoding/transrating service point along the path, it establishes a session between the two endpoints via the transcoder/transrater. The signaling flow may become active for the first leg of the session (e.g., in pure P2P call). The transcoder may also work transparently (instead of as a normal MCU as a relay point). This may be used, for example, when instead of adopting the codec type, the goal is instead to just add FEC (forward error correction) to the media stream because one endpoint is behind a DSL (digital subscriber line) link with high BER (bit error rate), for example.

In another example, the embodiments are used for discovery and instantiation of multicast to unicast translation service points. In a streaming media session where one sender (or an MCU) needs to deliver the same media to multiple receivers, multicast is the preferred method for efficient delivery of the media because it is replicated optimally within the network. When the receiver sees that it needs to join a multicast media stream it first tries to use the on-path-flow signaling to perform CAC (call admission control) for the stream. In this example, the admission control fails either because there is no IP multicast reachability from the receiver to the source, or because there is not enough bandwidth. The receiver can distinguish these cases via the on-path flow signaling and respond as described below. The processes described below for automatic multicast/unicast translation, may be performed with or without the use of the session control manager 18.

In the first case, there is no information received because the on-path flow signaling could not perform correctly due to a lack of multicast reachability on the receiver client. The receiver performs a new on-path flow-signaling, which is unicasted towards the source. The signaling also contains instructions for each multicast/unicast conversion service point. Once this signaling reaches a service point, it will try to activate the service point, send a join to the multicast source, and perform CAC on the multicast stream. If this succeeds, the service point is active and provides a unicast stream to the receiver. If it fails due to missing connectivity to the source, the original admission control from the receiver proceeds further towards the source until it reaches a service point that does have connectivity to the source.

In the second case, the multicast stream cannot be admitted because of bandwidth constraints. The client will have also received the signaling about the available service point that can provide transcoding/transrating and multicast/unicast conversion. In order to maximize the reach of the multicast tree, the service point that is closest to the receiver is preferably chosen. The service point may be asked to perform the operation via the session control manager or directly from the receiver client.

It is to be understood that the implementations described above are only examples and that the embodiments described herein may be used in other implementations, without departing from the scope of the embodiments.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving at a session call manager, service information transmitted from one or more service points on a path for a media flow between a source and a receiver;
selecting from said service information, services to apply to the media flow at said one or more service points; and
signaling said one or more service points to apply said selected services to the media flow.

2. The method of claim 1 wherein receiving said service information comprises receiving said service information from the source or the receiver.

3. The method of claim 2 further comprising signaling at least one of the source and the receiver, the selected services for said one or more service points.

4. The method of claim 1 wherein the session call manager is located at the source or the receiver.

5. The method of claim 1 further comprising discovering a change in said path and signaling a new service point to apply one of said selected services to the media flow.

6. The method of claim 1 further comprising locking one of the service points to the media flow.

7. The method of claim 1 wherein said service information comprises services available at the service point and contact information for the service point.

8. The method of claim 7 wherein said service information further comprises properties of said services.

9. The method of claim 1 wherein the service point comprises a multipoint control unit.

10. The method of claim 1 wherein the service point is configured to monitor the media flow and provide monitoring information to another network device.

11. The method of claim 1 wherein the service point comprises a transcoder/transrater.

12. The method of claim 1 wherein the service point is configured to perform multicast/unicast conversion.

13. An apparatus comprising:
a processor for receiving service information transmitted from one or more service points on a path for a media flow between a source and a receiver, selecting services to apply to the media flow at said one or more service points, and signaling said one or more service points to apply said selected services to the media flow; and
memory for storing said service information.

14. The apparatus of claim 13 wherein the apparatus is located at the source or the receiver.

15. The apparatus of claim 13 wherein the processor is further operable to discover a change in said path and signal a new service point to apply one of said selected services to the media flow.

16. The apparatus of claim 13 wherein the processor is further operable to lock one of the service points to the media flow.

17. An apparatus comprising:
a processor for inserting service information identifying a service available at a service point into flow signaling on a path for a media flow between a source and a receiver, receiving instructions from a session control manager to perform said service for the media flow, and applying said service to the media flow; and
memory for storing said instructions.

18. The apparatus of claim 17 wherein the service point is configured to monitor the media flow and provide monitoring information to another network device.

19. The apparatus of claim 17 wherein the service point comprises a transcoder/transrater.

20. The apparatus of claim 17 wherein the service point is configured to perform multicast/unicast conversion.
